(19) United States
(12) Patent Application Publication
(10) Pub. No.: US 2026/0177503 A1
(43) Pub. Date: Jun. 25, 2026

(54) DEFECT DETECTION METHOD AND DEFECT DETECTION APPARATUS

(71) Applicant: NANYA TECHNOLOGY CORPORATION, New Taipei City (TW)

(72) Inventors: Chia Chung Lin, New Taipei City (TW); Su Te Ma, New Taipei City (TW)

(73) Assignee: NANYA TECHNOLOGY CORPORATION, New Taipei City (TW)

(21) Appl. No.: 19/000,600

(22) Filed: Dec. 23, 2024

(51) Int. Cl. G01N 21/88; G01N 21/45

(52) U.S. Cl. CPC G01N 21/8851; G01N 21/45

(57) ABSTRACT

A defect detection apparatus configured to detect a sample including a periodical structure. The defect detection apparatus includes a light source, an image detector, and a controller. The light source is configured to provide a light beam incident on the periodical structure, wherein the periodical structure converts the light beam into an interference beam. The image detector is disposed on a path of the interference beam, wherein the interference beam forms an interference intensity distribution on the image detector. The controller is electrically connected to the image detector and configured to determine whether the periodical structure has a defect by determining whether the interference intensity distribution has a normal waveform. A defect detection method is also provided.

### BACKGROUND

### Technical Field

The invention generally relates to an optical detection method and an optical detection apparatus and, in particular, to a defect detection method and a defect detection apparatus.

### Description of Related Art

Semiconductor process shrinkage requires special attention not only to line width and overlay, but also to defect analysis. The currently used defect inspection machines are image detectors and electron beam detectors. Image defect inspection machine is unable to detect tiny defects and is unable to catch asymptotic defects during overlay comparison. On the other hand, electron beam inspection machines are expensive machines and have slow measurement time due to the electron beam needing time for scanning a sample.

### SUMMARY

Accordingly, the invention is directed to a defect detection method, which has higher detection rate and short detection time.

The invention is directed to a defect detection apparatus, which has higher detection rate and short detection time.

An embodiment of the invention provides a defect detection method including: providing a sample, wherein the sample includes a periodical structure; irradiating the periodical structure by a light beam, wherein the periodical structure converts the light beam into an interference beam; receiving the interference beam by an image detector, wherein the interference beam forms an interference intensity distribution on the image detector; and determining whether the periodical structure has a defect by determining whether the interference intensity distribution has a normal waveform.

An embodiment of the invention provides a defect detection apparatus configured to detect a sample including a periodical structure. The defect detection apparatus includes a light source, an image detector, and a controller. The light source is configured to provide a light beam incident on the periodical structure, wherein the periodical structure converts the light beam into an interference beam. The image detector is disposed on a path of the interference beam, wherein the interference beam forms an interference intensity distribution on the image detector. The controller is electrically connected to the image detector and configured to determine whether the periodical structure has a defect by determining whether the interference intensity distribution has a normal waveform.

In the defect detection method and the defect detection apparatus according to the embodiments of the invention, whether the periodical structure has a defect is determined by determining whether the interference intensity distribution has a normal waveform, so that a higher detection rate and short detection time are achieved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a defect detection apparatus according to an embodiment of the invention.

FIG. 2 shows the generation of the interference beam from the sample in FIG. 1.

FIG. 3A shows a top view of the periodical structure in FIG. 1 without a defect and a corresponding interference intensity distribution curve.

FIG. 3B shows a top view of the periodical structure in FIG. 1 with defects and a corresponding interference intensity distribution curve.

FIG. 4 is a flow chart of a defect detection method according to an embodiment of the invention.

FIG. 5 is a flow chart of a calibration method for the defect detection apparatus in FIG. 1.

### DESCRIPTION OF THE EMBODIMENTS

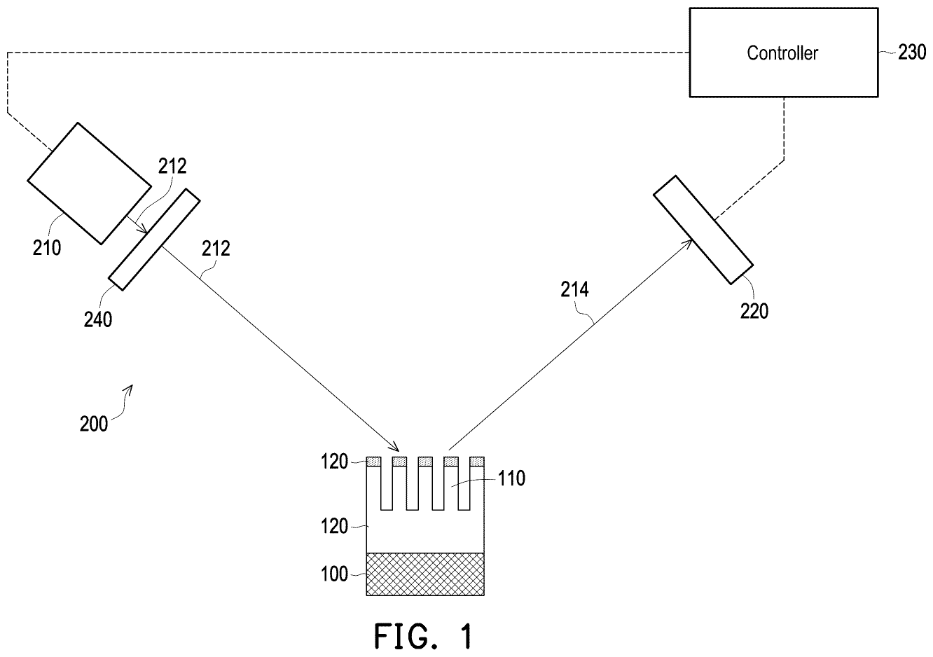

FIG. 1 is a schematic view of a defect detection apparatus according to an embodiment of the invention. Referring to FIG. 1, the defect detection apparatus 200 in this embodiment is configured to detect a sample 100 including a periodical structure 110. The defect detection apparatus 200 includes a light source 210, an image detector 220, and a controller 230. The light source 210 is configured to provide a light beam 212 incident on the periodical structure 110, wherein the periodical structure 110 converts the light beam 212 into an interference beam 214. In this embodiment, the light source 210 is, for example, a mercury lamp, and the defect detection apparatus 200 further includes a filter 240 disposed on a path of the light beam 212 between the periodical structure 110 and the light source 210, wherein a bandwidth of the light beam 212 after passing through the filter 240 is less than a bandwidth of the light beam 212 before passing through the filter 240. For example, the light beam 212 emitted by the light source 210 has a broad bandwidth, and the light beam 212 becomes a light beam having about a single wavelength after passing through the filter 240. In other embodiments, the light source 210 may be any other suitable light source.

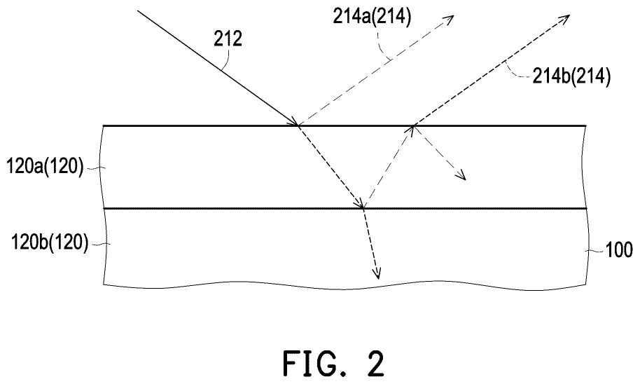

FIG. 2 shows the generation of the interference beam from the sample in FIG. 1. Referring to FIG. 1 and FIG. 2, the sample 100 may have a plurality of layers 120 (for example, including a layer 120a and a layer 120b), the layers 120 may have different refractive indexes. In this embodiment, the light beam 212 is obliquely incident on the periodical structure 110, and the periodical structure 110 may have a plurality of stacked layers 120. As shown in FIG. 2, the top surface of the layer 120a (i.e. the interface between air and the layer 120a) may reflect a part of the light beam 212 into a light beam 214a, and allow the other part of the light beam to pass through and to be at least partially reflected by the interface between the layer 120a and the layer 120b into a light beam 214b. The light beam 214b then passes through the top surface of the layer 120a and interferes with the light beam 214a to form the interference beam 214. In addition, a part of the light beam may pass through the layers 120a and 120b and be reflected by other interfaces under the layer 120b and then interferes with the light beams 214a and 214b to form the interference beam 214, and the number of the interfaces is not limited by the invention.

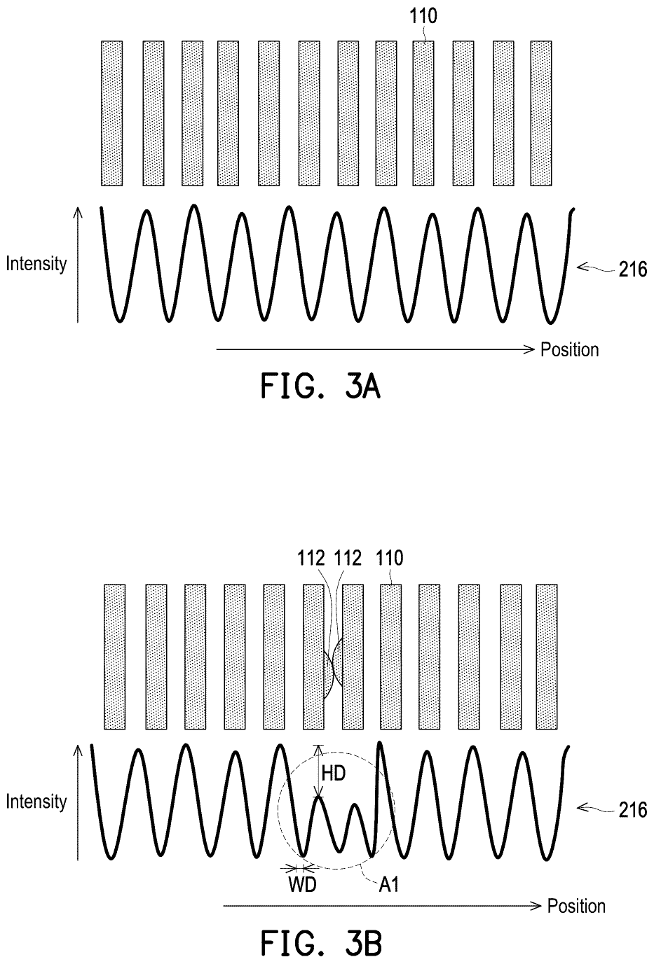

The image detector 220 is disposed on a path of the interference beam 214, wherein the interference beam 214 forms an interference intensity distribution (as shown in FIG. 3A and FIG. 3B) on the image detector 220. FIG. 3A shows a top view of the periodical structure in FIG. 1 without a defect and a corresponding interference intensity distribution curve, and FIG. 3B shows a top view of the periodical structure in FIG. 1 with defects and a corresponding interference intensity distribution curve. Referring to FIG. 1, FIG. 3A, and FIG. 3B, the controller 230 is electrically connected to the image detector 220 and configured to determine whether the periodical structure 110 has a defect 112 by determining whether the interference intensity distribution 216 has a normal waveform. For example, in FIG. 3A, the periodical structure 110 has no defect, so that the waveform of the corresponding interference intensity distribution 216 is normal and has some regularity. However, in FIG. 3B, the periodical structure 110 has defects 112, so that the waveform of the corresponding interference intensity distribution 216 is abnormal. For example, the waveform in region μl is abnormal and different from the waveform in neighbor regions. For the interference intensity distribution 216 in FIG. 3A and FIG. 3B, the vertical axis is the intensity of the interference beam 214 detected by the image detector 220, and the horizontal axis is the positions on the sensing surface of the image detector 220 which can correspond to the positions of the periodical structure 110.

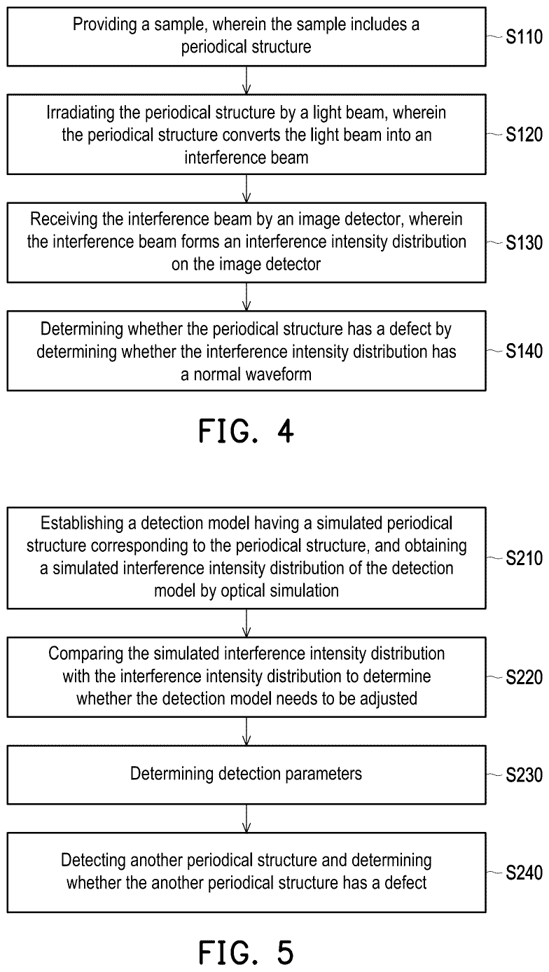

FIG. 4 is a flow chart of a defect detection method according to an embodiment of the invention. Referring to FIG. 4 the defect detection apparatus 200 may be used to perform a defect detection method, and the defect detection method in this embodiment includes the following steps. First, step S110 is performed, in which a sample 100 is provided, wherein the sample 100 includes a periodical structure 110. Next, step S120 is performed, in which the periodical structure 110 is irradiated by a light beam 212, wherein the periodical structure 110 converts the light beam 212 into an interference beam 214. In this embodiment, the controller 230 may be electrically connected to the light source 210, and may command the light source 210 to emit the light beam 212. Then, step S130 is performed, in which the interference beam 214 is received by an image detector 220, wherein the interference beam 214 forms an interference intensity distribution on the image detector 220. In this embodiment, the controller 230 may command the image detector 220 to detect the interference beam 214 and obtain the interference intensity distribution from the image detector 220. Moreover, in this embodiment, the image detector 220 may include a complementary metal oxide semiconductor (CMOS) image sensor or a charge coupled device (CCD). After that, step S140 is performed, in which whether the periodical structure 110 has a defect is determined by determining whether the interference intensity distribution has a normal waveform. In this embodiment, step S140 may be performed by the controller 230. The details of the defect detection method have been described in the aforementioned embodiment of FIS. 1, FIG. 2, FIG. 3A, and FIG. 3B, and will not be repeated hereinafter.

In the defect detection method and the defect detection apparatus 200 in this embodiment, whether the periodical structure 110 has a defect is determined by determining whether the interference intensity distribution has a normal waveform, and it can be performed by determining whether the difference between a portion of the waveform and neighbor portions of the wave form exceeds a predetermined threshold value. As a result, whether the periodical structure 110 has a defect can be determined by the signal of the periodical structure 110 itself, but does not need to compare the signal of the periodical structure 110 with the signal of previously detected periodical structures. Therefore, a higher detection rate can be achieved, tiny defects and asymptotic defects can be found. Moreover, since an electron beam scanning the sample is not used in the defect detection method and the defect detection apparatus 200 in this embodiment, short detection time is achieved.

In this embodiment, the structure of the light source 210, the filter 240, and the image detector 220 may form an ellipsometer, and two polarizers may be disposed on the path of the light beam 212 and the path of the interference beam 214, respectively. The transmission axes of the two polarizers may be rotated to achieve a clear interference intensity distribution on the image detector 220.

FIG. 5 is a flow chart of a calibration method for the defect detection apparatus in FIG. 1. Referring, before a plurality of periodical structures 110 are detected by the defect detection apparatus 200, a calibration method for the defect detection apparatus 200 may be performed, for example, by the controller 230. The calibration method or the defect detection method in this embodiment includes the following steps. First, step S210 is performed, in which a detection model having a simulated periodical structure corresponding to the periodical structure 110 is established, and a simulated interference intensity distribution of the detection model is obtained by optical simulation. The detection model is a simulation model in the controller and simulates the structure in FIG. 1.

Next, step S220 is performed, in which the simulated interference intensity distribution is compared with the interference intensity distribution obtained by the defect detection apparatus 200 in FIG. 1 to determine whether the detection model needs to be adjusted. If the difference between the simulated interference intensity distribution and the real interference intensity distribution is too large, the detection model is adjusted, and the optical simulation in step S210 is repeated, and step S220 is then repeated. If the difference is small, step S230 is performed, in which detection parameters are determined. In this embodiment, the detection parameters includes a threshold value of a height difference HD (as shown in FIG. 3B) or a width difference WD (as shown in FIG. 3B) of a waveform of the interference intensity distribution. If the height difference HD or the width difference WD exceeds a threshold value, the controller 230 determines that the waveform is abnormal and the periodical structure 110 has a defect. If the height difference HD or the width difference WD does not exceed a threshold value, the controller 230 determines that the waveform is normal and the periodical structure 110 does not have a defect.

After step S230, the calibration of defect detection apparatus 200 is finished. After that, step S240 is performed, in which another periodical structure 110 is detected and whether the another periodical structure 110 has a defect is determined. In this embodiment, a plurality of periodical structures 110 may then be detected and whether the periodical structures have a defect may then be determined.

In the defect detection method and the defect detection apparatus according to the embodiments of the invention, whether the periodical structure has a defect is determined by determining whether the interference intensity distribution has a normal waveform, so that a higher detection rate and short detection time are achieved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A defect detection method comprising:
providing a sample, wherein the sample comprises a periodical structure;
irradiating the periodical structure by a light beam, wherein the periodical structure converts the light beam into an interference beam;
receiving the interference beam by an image detector, wherein the interference beam forms an interference intensity distribution on the image detector; and
determining whether the periodical structure has a defect by determining whether the interference intensity distribution has a normal waveform.

2. The defect detection method according to claim 1 further comprising:
establishing a detection model having a simulated periodical structure corresponding to the periodical structure;
obtaining a simulated interference intensity distribution of the detection model by optical simulation;
comparing the simulated interference intensity distribution with the interference intensity distribution to determine whether the detection model needs to be adjusted;
determining detection parameters; and
detecting another periodical structure and determining whether the another periodical structure has a defect.

3. The defect detection method according to claim 2, wherein the detection parameters comprising a threshold value of a height difference or a width difference of a waveform of the interference intensity distribution.

4. The defect detection method according to claim 1, wherein the light beam is obliquely incident on the periodical structure.

5. The defect detection method according to claim 1, wherein the light beam is emitted from a light source through a filter, and a bandwidth of the light beam after passing through the filter is less than a bandwidth of the light beam before passing through the filter.

6. A defect detection apparatus configured to detect a sample comprising a periodical structure, the defect detection apparatus comprising:
a light source configured to provide a light beam incident on the periodical structure, wherein the periodical structure converts the light beam into an interference beam;
an image detector disposed on a path of the interference beam, wherein the interference beam forms an interference intensity distribution on the image detector; and
a controller electrically connected to the image detector and configured to determine whether the periodical structure has a defect by determining whether the interference intensity distribution has a normal waveform.

7. The defect detection apparatus according to claim 6, wherein the controller is configured to perform:
establishing a detection model having a simulated periodical structure corresponding to the periodical structure;
obtaining a simulated interference intensity distribution of the detection model by optical simulation;
comparing the simulated interference intensity distribution with the interference intensity distribution to determine whether the detection model needs to be adjusted;
determining detection parameters; and
detecting another periodical structure and determining whether the another periodical structure has a defect.

8. The defect detection apparatus according to claim 7, wherein the detection parameters comprising a threshold value of a height difference or a width difference of a waveform of the interference intensity distribution.

9. The defect detection apparatus according to claim 6, wherein the light beam is obliquely incident on the periodical structure.

10. The defect detection apparatus according to claim 6 further comprising a filter disposed on a path of the light beam between the periodical structure and the light source, wherein a bandwidth of the light beam after passing through the filter is less than a bandwidth of the light beam before passing through the filter.
